(19) United States
(12) Patent Application Publication
(10) Pub. No.: US 2023/0131537 A1
(43) Pub. Date: Apr. 27, 2023

(54) NETWORK SCHEDULING OF MULTIPLE ENTITIES

(71) Applicant: Telefonaktiebolaget LM Ericsson (publ), Stockholm (SE)

(72) Inventors: Rickard EVERTSSON, Lund (SE); Staffan MÅNSSON, Åkarp (SE); Anders ELGCRONA, Täby (SE)

(21) Appl. No.: 17/911,283

(22) PCT Filed: Mar. 8, 2021
(86) PCT No.: PCT/EP2021/055815

§ 371 Date: Sep. 13, 2022

Related U.S. Application Data
(60) Provisional application No. 62/993,285, filed on Mar. 23, 2020.

(51) Int. Cl. H04W 72/1263; H04W 72/52

(52) U.S. Cl. CPC H04W 72/1263; H04W 72/52

(57) ABSTRACT

A method for scheduling a plurality of network entities of a network for transmissions. The method includes determining a handling capacity of a processing device, the handling capacity relating to a maximum number of network entities which the processing device can handle during a given period of time and determining a network entity schedule for transmission in uplink and downlink based on the handling capacity of the processing device by scheduling a first set of network entities of the plurality of network entities to transmit in uplink and downlink in a transmission block according to a first transmission pattern. A second set of network entities is scheduled to transmit in the transmission block in uplink and downlink according to a second transmission pattern, the first transmission pattern differs from the second transmission pattern and the first and second transmission patterns conform to the handling capacity of the processing device.

### TECHNICAL FIELD

The present invention relates generally to the field of wireless communication. More particularly, it relates to network scheduling of multiple entities.

### BACKGROUND

There is a common opinion that future communication networks will comprise a massive amount of entities such as multiple cells, network sections and carriers as well as a multitude of connected devices. In order to be able to handle the communication associated with such a large number of entities and devices, new scheduling methods are needed.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above disadvantages and to provide a method for a processing device and a processing device for enabling scheduling of multiple network entities.

According to a first aspect, this is achieved by a method of a processing device for scheduling a plurality of network entities of a network for transmissions in uplink and downlink. The method comprises determining a handling capacity of the processing device. The handling capacity relates to a maximum number of network entities which the processing device can handle during a given period of time. The method also comprises determining a network entity schedule for transmission in uplink and downlink based on the handling capacity of the processing device by scheduling a first set of network entities of the plurality of network entities to transmit in uplink and downlink in a transmission block according to a first transmission pattern, and scheduling a second set of network entities of the plurality of network entities to transmit in the transmission block in uplink and downlink according to a second transmission pattern. The first transmission pattern differs from the second transmission pattern and the first and second transmission patterns conform to the handling capacity of the processing device.

In some embodiments, the transmission block comprises at least one transmission interval, wherein uplink and downlink is scheduled in a respective transmission interval or part of a respective interval.

In some embodiments, the transmission block comprises at least one transmission interval.

In some embodiments, the transmission block comprises at least one transmission interval, wherein the at least one transmission interval is fully allocated to the first and second set of network entities.

In some embodiments, all transmission intervals of a transmission block are fully allocated.

In some embodiments, a transmission interval of a transmission block is at least one of a transmission slot, transmission symbol, and a transmission time interval.

In some embodiments, a transmission interval is measured in at least one of a time period and frequency range.

In some embodiments, a transmission interval is a transmission block.

In some embodiments, a subset of transmission intervals of the transmission block are allocated to the first and the second set of network entities.

In some embodiments, a subset of transmission intervals of the transmission block are unallocated.

In some embodiments a first subset of transmission intervals of the transmission block is allocated to the first and second set of network entities. The network entity scheduling further comprises scheduling a third set of network entities of the plurality of network entities to transmit in uplink and downlink in a second subset of transmission intervals of the transmission block according to a third transmission pattern, and scheduling a fourth set of network entities of the plurality of network entities to transmit in uplink and downlink in the second subset of transmission intervals of the transmission block according to a fourth transmission pattern, wherein the first, second, third fourth transmission pattern differs from each other.

In some embodiments, a transmission block is a period measured in one or more of time and frequency.

In some embodiments, the uplink and downlink is scheduled in a respective transmission interval.

In some embodiments, uplink and downlink is scheduled in a same transmission interval.

In some embodiments, the handling capacity of the processing device is based on an Input vs Output (IO) capacity of the processing device.

In some embodiments IO capacity of the processing device relates to a bandwidth of the processing device.

In some embodiments the handling capacity of the processing device is based on a computing capacity of the processing device.

In some embodiments, a network entity is at least one of a network cell, network section, a radio unit and a network carrier for transmission.

In some embodiments, determining a network entity schedule comprises scheduling the plurality of network entities such that all active communication devices connected to each of the plurality of network entities are scheduled to transmit and receive in uplink and downlink respectively in each of the plurality of network entities at the same period of time. The method further comprises the processing device entering a power saving mode when all active communication devices have been scheduled.

In some embodiments, determining a network entity schedule is based on determining one or more synergies between one or more network entities of the plurality of network entities and scheduling the one or more network entities based on the determined synergies.

A second aspect is computer program product comprising a non-transitory computer readable medium. The non-transitory computer readable medium has stored there on a computer program comprising program instructions. The computer program is configured to be loadable into a data-processing unit, comprising a processor and a memory associated with or integral to the data-processing unit. When loaded into the data-processing unit, the computer program is configured to be stored in the memory, wherein the computer program, when loaded into and run by the processor is configured to cause the execution of the method steps according to the first aspect.

A third aspect is a processing device for scheduling a plurality of network entities of a network for transmissions in uplink and downlink. The processing device comprising a controller configured to cause determination of a handling capacity of the processing device. The handling capacity relates to a maximum number of network entities which the processing device can handle during a given period of time. The controller is also configured to cause determination of a network entity schedule for transmission in uplink and downlink based on the handling capacity of the processing device by scheduling a first set of network entities of the plurality of network entities to transmit in uplink and downlink in a transmission block according to a first transmission pattern, and cause scheduling of a second set of network entities of the plurality of network entities to transmit in the transmission block in uplink and downlink according to a second transmission pattern. The first transmission pattern differs from the second transmission pattern and the first and second transmission patterns conform to the handling capacity of the processing device.

In some embodiments, the transmission block comprises at least one transmission interval, wherein uplink and downlink is scheduled in a respective transmission interval or part of a respective interval.

In some embodiments, the transmission block comprises at least one transmission interval, wherein the at least one transmission interval is fully allocated to the first and second set of network entities.

In some embodiments, a transmission interval of a transmission block is at least one of a transmission slot, transmission symbol, and a transmission time interval.

In some embodiments, a subset of transmission intervals of the transmission block are allocated to the first and the second set of network entities.

In some embodiments, a subset of transmission intervals of the transmission block are unallocated.

In some embodiments, the controller is configured to cause allocation of a first subset of transmission intervals of the transmission block to the first and second set of network entities. The network entity scheduling further comprises causing scheduling of a third set of network entities of the plurality of network entities to transmit in uplink and downlink in a second subset of transmission intervals of the transmission block according to a third transmission pattern, and causing scheduling of a fourth set of network entities of the plurality of network entities to transmit in uplink and downlink in the second subset of transmission intervals of the transmission block according to a fourth transmission pattern. The first, second, third fourth transmission pattern differs from each other.

In some embodiments, a transmission block is period measured in one or more of time and frequency.

In some embodiments, the transmission block comprises transmission intervals, and uplink and downlink is scheduled in a respective transmission interval.

In some embodiments, the transmission block comprises transmission intervals, and uplink and downlink is scheduled in a same transmission interval.

In some embodiments, the handling capacity of the processing device is based on an Input vs Output (IO) capacity of the processing device.

In some embodiments, the IO capacity of the processing device relates to a bandwidth of the processing device.

In some embodiments, the handling capacity of the processing device is based on a computing capacity of the processing device.

In some embodiments, a network entity is at least one of a network cell, network section, radio unit and network carrier for transmission.

In some embodiments, causing determination of a network entity schedule comprises causing scheduling of the plurality of network entities such that all active communication devices connected to each of the plurality of network entities are scheduled to transmit and receive in uplink and downlink respectively in each of the plurality of network entities at the same period of time. The controller is further configured to cause entering into a power saving mode when all active communication devices have been scheduled.

In some embodiments, causing determination of a network entity schedule is based on causing determination of one or more synergies between one or more network entities of the plurality of network entities and causing scheduling of the one or more network entities based on the determined synergies.

In some embodiments, the processing device comprises hardware comprising one or more processing elements configured to process computations, in parallel.

In some embodiments, the hardware is comprised in a GPU (graphics processing unit).

In some embodiments, any of the above aspects may additionally have features identical with or corresponding to any of the various features as explained above for any of the other aspects.

An advantage of some embodiments is that the described scheduling allows for a large amount of network entities and communication devices to be scheduled and handled by a single processor.

Another advantage of some embodiments is that the scheduling described herein reduces network energy consumption.

Another advantage with some of the embodiments herein is that they enable enhanced network performance compared to current network performance.

### BRIEF DESCRIPTION OF THE DRAWINGS

Further objects, features and advantages will appear from the following detailed description of embodiments, with reference being made to the accompanying drawings, in which:

FIG. 1 is a is a schematic drawing illustrating a network topology according to some embodiments;

FIG. 2 is a flowchart illustrating example method steps according to some embodiments;

FIG. 3 is a schematic drawing illustrating a transmission pattern according to some embodiments;

FIG. 4 is a schematic drawing illustrating a transmission pattern according to some embodiments;

FIG. 5 is a schematic drawing illustrating a transmission pattern according to some embodiments;

FIG. 6 is a schematic drawing illustrating a transmission pattern according to some embodiments;

FIG. 7 is a schematic drawing illustrating a computer program product according to some embodiments; and

FIG. 8 is a block diagram illustrating an example processing device according to some embodiments.

### DETAILED DESCRIPTION

In the following, embodiments will be described where network scheduling by a processing device of multiple network entities is enabled.

In a scenario where a node (e.g. a network node, server, core network, cloud implementation, virtual entity, base station, eNB, gNB etc., when a node is referred to in this disclosure it is to correspond to any of the previously mentioned, or similar, entities) processes hundreds, if not thousands, of cells (or other network entities such as network sections, radio units or network carriers, in this disclosure, the term network cell or just cell may be used interchangeably with the terms network entities, network sections, radio unit and network carrier. The term cell is to be seen as an example) it may be beneficial to consider the capabilities of the node when scheduling the communication devices in the different cells. There is typically a risk that the node cannot cope with the high load of processing and/or traffic or that the node isn't optimally utilized if the capabilities of the network node are not taken into consideration when scheduling.

New and coming processing devices are expected to have a large processing/computing capacity which may enable the network node to actually handle a large number of network entities. A large number may be in the range of hundreds, thousands, or even ten thousands of entities.

Such a processing device may e.g. be a graphics processing unit (GPU) comprising one or more processing elements, wherein each of the processing elements is configured to process computations independently from each other. Although these type of processors are typically associated with rendering of graphics they have an incredibly high processing capability and can thus be used for other processes that are demanding in terms of computing resources.

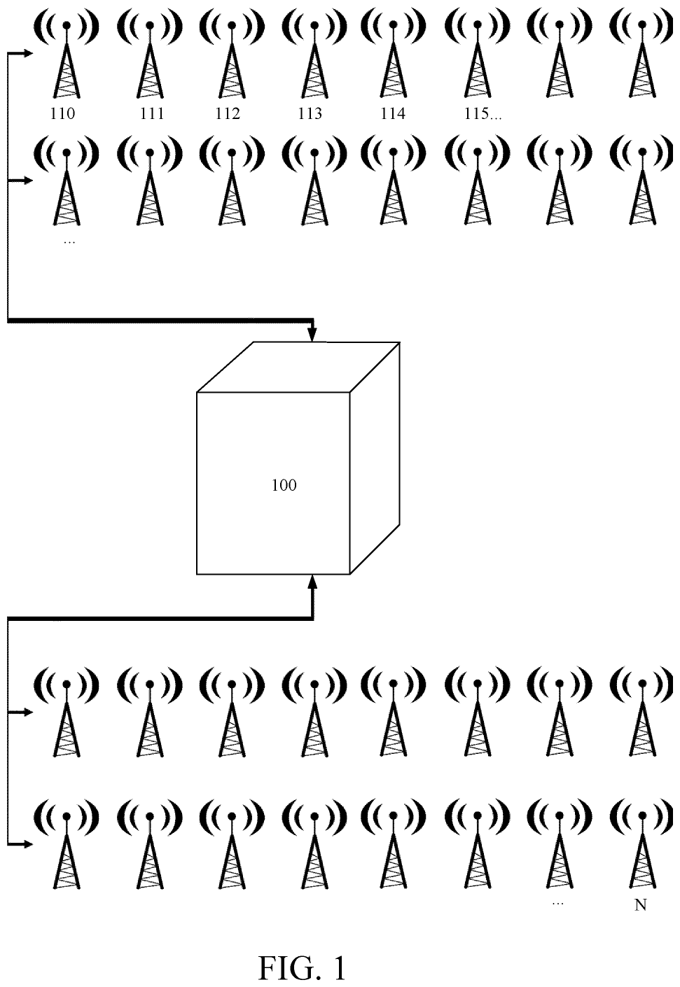

FIG. 1 illustrates a network scenario according to some embodiments. In FIG. 1, a node comprising a processing device 100 is deployed such that it may perform the scheduling and processing of many radios/cells (i.e. network entities) 110,111,112 . . . N. The radios/cells may be of different numerologies and different 3GPP (third generation partnership project) generations. The processing device 100 may perform Layer 2 scheduling and Layer 1 processing in uplink and downlink.

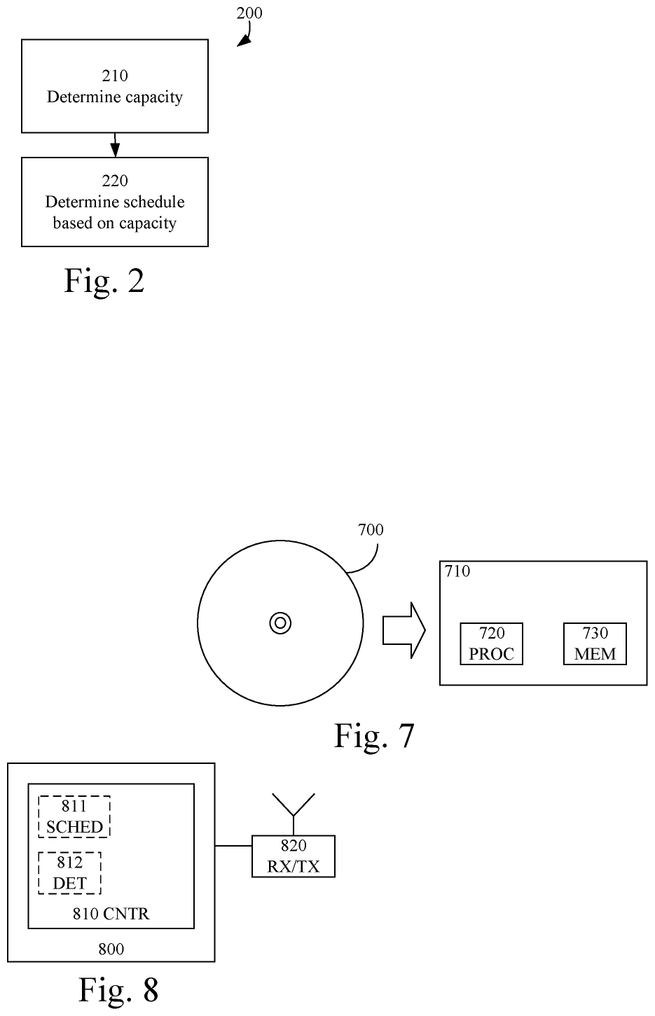

FIG. 2 illustrates a method 200 according to some embodiments. The method 200 is of a processing device for scheduling a plurality of network entities of a network for transmissions in uplink and downlink. The method 200 may e.g. be carried out by the processing device 100 described in FIG. 1.

The method starts in step 210 with determining a handling capacity of the processing device. The handling capacity relates to a maximum number of network entities which the processing device can handle during a given period of time. Then, the method continues in step 220 with determining a network entity schedule for transmission in uplink and downlink based on the handling capacity of the processing device by scheduling a first set of network entities of the plurality of network entities to transmit in uplink and downlink in a transmission block according to a first transmission pattern, and scheduling a second set of network entities of the plurality of network entities to transmit in the transmission block in uplink and downlink according to a second transmission pattern. The first transmission pattern differs from the second transmission pattern and the first and second transmission patterns conform to the handling capacity of the processing device.

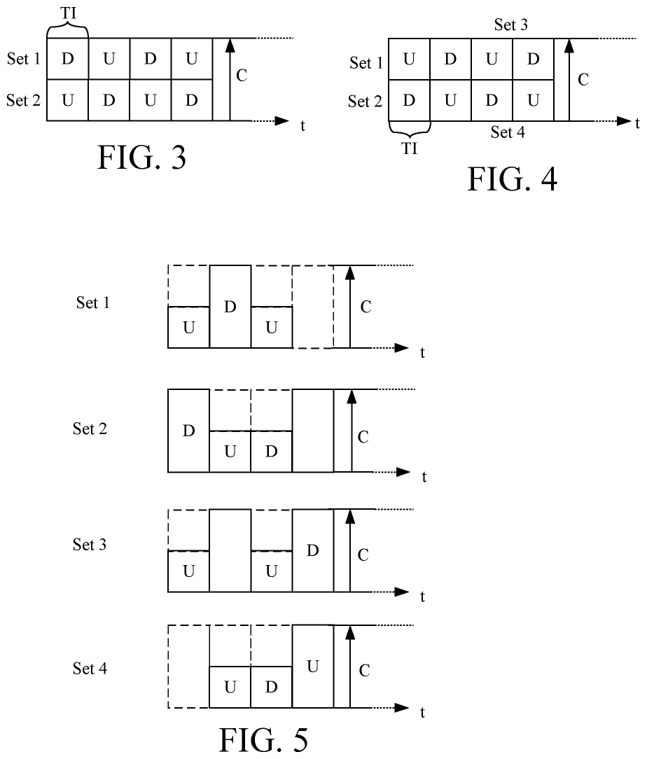

The transmission patterns may e.g. differ from each other according to what is described in conjunction with any of the FIGS. 3-6.

Network entities may e.g. relate to cells, network section, radio units and/or network carriers for transmitting traffic to and from the radio units (compare with FIG. 1). It should be noted that whenever the term cell is used in this disclosure in relation to scheduling, it may be interchanged with either of a network section, radio unit and network carrier. Hence, in some embodiments, a network entity is at least one of a network cell, network section, radio unit and a network carrier for transmission. For simplicity, in this disclosure, reference is often made to a cell as an example, but as noted the embodiments described herein may be applicable on other entities such as network sections, radio units and/or other network carriers for transmission.

In some embodiments, a transmission block is a period measured in one or more of time and frequency.

In some embodiments, the transmission blocks comprises transmission intervals, and wherein uplink and downlink is scheduled in a respective transmission interval.

In some embodiments, a transmission block may comprise one or more transmission interval.

Hence, in some embodiments, a transmission block may be a transmission interval. The transmission block and/or transmission interval may be measured in one or more of a time period and a frequency range.

In some embodiments, the transmission block comprises at least one transmission interval, and uplink and downlink is scheduled in a same transmission interval.

In some embodiments, the handling capacity of the processing device is based on an Input vs Output (IO) capacity of the processing device.

In some embodiments, the handling capacity of the processing device is based on a computing capacity of the processing device.

Typically, in a system like that described in FIG. 1 or applicable for the method according to FIG. 2 there are synergies that may be considered when performing scheduling.

The scheduling of uplink and downlink may e.g. be based on input/output (IO) capabilities of the processing device. Parameters that may dictate the IO capabilities may e.g. be bandwidth of the processing device.

It may e.g. be that the Processing device 100 cannot perform e.g. Uplink PUSCH (physical uplink shared channel) for hundreds of cells at the same time and/or in the same frame/sub frame/slot/symbol. The Processing device 100 may e.g. lack sufficient IO capacity, the processing power may not be high enough, or the Processing device 100 may not be utilized in an optimal way with regard to latency or power efficiency.

In an uplink slot (it should be noted that the term slot may be used interchangeably with the term transmission interval in this disclosure) the processing device may receive IQ (in-phase quadrature) data from the radio units deployed in the communication network, and in downlink the processing device may transmit IQ data to the radio units. The connections are typically full duplex (i.e. data can flow in both directions at the same time).

Considering a low band TDD (time division duplex) example scenario. It should be noted that all of the below numerical values are purely exemplary and chosen in order to provide better understanding of the embodiments herein. Other numerical values than those disclosed below for e.g. denoting the maximum number of cells (network entities) may be contemplated:

A symbol in Time Domain is 1536 IQ samples, which is 6144 bytes. There are 14 symbols+1 symbol extra for cyclic prefix. This sums up to 92160 bytes IQ Data per antenna. Hence, a carrier with 4 baseband ports have 4×92160 bytes=368640 bytes per scheduled uplink TTI (transmission time interval). If one sector cell is assumed, and if this cell schedules uplink in all slots it will require a data throughput of 352 MB/s.

Considering IO capabilities: The Processing device 100 runs on a standard server which has a PCI (peripheral component interconnect) Express 3.0 bus with 16 lanes which, theoretically, can handle 16 GB/s (in practice it is typically closer to 12 GB/s). The Processing device may have 200 Gbps Network Interfaces which also can manage well above 12 GB/s. Based on the limitations of the PCI Express and Network Interface the Processing device can process 30 Cells with full allocation uplink. And since the IO is in full duplex, the processing device can handle yet another 30 cells with full allocations in downlink. In total the processing device may handle 60 cells.

I.e. 30 cells are scheduled with the transmission pattern (i.e., TDD, time division duplex, pattern) DUDU (D=downlink/U=uplink) and another 30 cells are scheduled with the transmission pattern UDUD and in total the Processing Unit continuously manage 60 cells with full allocations.

This is e.g. illustrated by FIG. 3, where a first set of cells (Set 1), e.g. the first 30 cells according to the above example and a second set of cells (Set 2) e.g. the 30 other cells of the above example, have been scheduled in a transmission block comprising a plurality of transmission intervals (TI) (The term transmission block should be seen as a way to illustrate a transmission period, and may correspond to one or more transmission intervals in terms of frequency and/or time). The arrow denoted by C illustrates capacity of the processing device, and the arrow denoted by t illustrates time. Transmission in uplink and downlink can be carried out simultaneously for the first set of cells (Set 1) and a second set of cells (set 2) as long as the transmission pattern of the two sets don't coincide. Hence, the transmission patterns of the first set of cell and the second set of cell are different from each other, the first set of cells can be scheduled to transmit in uplink in a transmission interval whereas the second set of cells can be scheduled to receive in downlink in the same transmission interval.

It may also be noted that a typical power consumption of the Processing device 100 may be 600 W (which may be comprise e.g. 300 W to the GPU+300 W to the CPU (central processing unit) which may both form part of the processing device). If the processing device schedules 60 cells it would mean that approximately 10 W are used per cell. 10 W in this context is a relatively small power consumption.

It should also be noted, that the term transmission interval may encompass terms such as transmission slot and transmission symbol. A transmission interval may e.g. comprise a number of transmission slots and/or symbols. However, the embodiments described herein may not only relate to slots and symbols, but may also relate to a transmission time period. Thus, the transmission interval may also relate to a period of time.

It should also be noted that the FIGS. 3-5 describe various embodiments for network entity scheduling and transmission patterns, with some common/shared terms. Hence the cell sets described as an example in the figures may be the same for all of the figures but illustrated in various embodiments where they are scheduled according to different example patterns. Similarly the transmission blocks may be the same and the transmission intervals may be the same. It should also be noted that the embodiments can be taken separately or be combined to comprise one or more of the embodiments according to FIGS. 3-6.

Another scenario is to Schedule/Load balance more cells than can be handled based on the IO capabilities.

With reference to the example above, the Processing device may be able to handle 60 cells, when all transmission intervals are fully allocated, continuously (as is e.g. illustrated in FIG. 3 where all TIs are fully allocated).

Hence, in some embodiments all transmission intervals of the transmission block are fully allocated to the first and second set of network entities.

FIG. 3 maps on the method according to FIG. 2, in that the maximum handling capacity of the processing device is based on the IO capability of the processing device, and that the transmission patterns has been scheduled such that it conforms to the maximum handling in a way that the capacity is not exceeded.

However, in some embodiments the processing device may be enabled to handle more cells, e.g. 120 cells. But, since the IO capabilities of the processing device limits the number of cells that the processing device can manage when fully allocated, the maximum number of cells can typically only be increased if the number of transmission intervals allocated to a set of cells is reduced in order to make room for more cells.

It may e.g. be considered that 30 cells may have the TDD pattern (i.e. transmission pattern) UDUD and another 30 cells the pattern DUDU. However, in order to cater for more cells, every second uplink and every second downlink are left unallocated (not allocated to the first and second set of cells) and hence no IQ data is transmitted/received in these intervals.

The TDD patterns for the first and second set of cells would be UDUD and DUDU (where added emphasis marks allocated transmission intervals). Thus, another 30 cells with TDD patter UDUD and another 30 with DUDU can be catered for in the unallocated slots (i.e. the slots that normally would be allocated to the first and second set). This gives scheduling of 120 cells in total.

This is e.g. illustrated by FIG. 4, where a transmission block is divided into transmission intervals (TI). When comparing to FIG. 3, the four transmission intervals which were fully allocated to the first set of cells (set 1) and the second set of cells (set 2) are now instead utilized by both the first set of cells, second set of cells, a third set of cells (set 3) and a fourth set of cells (Set 4) Two transmission intervals are fully allocated to the first and second set of cells transmitting with different patterns in uplink and downlink (i.e. the first set transmit in uplink when the second set transmit in downlink in the same transmission interval). Two transmission intervals (which in FIG. 3 was fully allocated to the first and second set) are now allocated to the third and fourth set of cells. This enables the processing device to cater for more cells than what may be denoted by its processing capacity were it to operate according to conventional methods.

The embodiments of FIG. 4 maps on the method 200 as described in FIG. 2 in that the processing device (e.g. the processing device 100 described in FIG. 1) may determine that the maximum handling capacity of the processing device can exceed the IO capacity based on what scheduling is used. The transmission patterns of the first and second set of cells differs from each other, and are scheduled such that they conform to the determined maximum handling capacity which capacity hence may exceed the IO capacity of the processing unity.

Furthermore, according to e.g. FIG. 4, a first subset of transmission intervals of the transmission block is allocated to the first and second set of network entities (set 1, set 2 of FIG. 4). Method steps of the network entity scheduling, e.g. according to the method 200 may further comprise scheduling a third set (set 3) of network entities of the plurality of network entities to transmit in uplink and downlink in a second subset of transmission intervals of the transmission block according to a third transmission pattern, and scheduling a fourth set (set 4) of network entities of the plurality of network entities to transmit in uplink and downlink in the second subset of transmission intervals of the transmission block according to a fourth transmission pattern. The first, second, third fourth transmission pattern differs from each other.

This scenario is contemplated to be applicable on several more set of network entities than just 4 as exemplified in the FIG. 3-5.

Hence, the method may comprise scheduling a Nth set of network entities of the plurality of network entities to transit in uplink and downlink in a Kth subset of transmission intervals of the transmission block according a Nth transmission pattern. Where N and K are integers that may be the same but may also differ from each other. Furthermore, the kth subset of transmission intervals may be allocated to N+Y set of network entities, where Y is an integer as long as the transmission patterns of the various sets are chosen such that they are different from each other.

It should also be noted that for the embodiments disclosed herein it is optional to group the transmission intervals into transmission blocks.

Furthermore, in FIG. 4 the first subset of transmission intervals may e.g. relate to the transmission intervals that are allocated to the first and second set of cells, whereas the second subset of transmission intervals may relate to the transmission intervals that are non-allocated/allocated to the third and fourth set of cells.

The above scenario describes transmission intervals as fully allocated to a number of sets of network entities or as completely empty.

However, each transmission interval typically consists of 14 symbols or transmission periods (it should be noted that other number of symbols are contemplated to fall within the embodiments disclosed herein, and further that symbols are just an example, other transmission periods are contemplated as is elaborated on below), and the same mechanism as described above can be based on utilizing one or more symbols instead of full intervals. This enables not only empty and full intervals, but everything in between. An interval (e.g. a slot) can, based on this, have an allocation in the range of 0% to 100% (in terms of time and/or frequency). The Processing device's scheduler would be responsible to load balance uplink and downlink allocation of e.g. 120 network entities (or more) so that the maximum peak at any given rate is less than e.g. 12 GB/s (12 GB/s is maximum for PCI 3.0 (Peripheral Component Interconnect) and is only an example. PCI 4.0 is e.g. faster, and it is contemplated that future systems will be even faster) symbol by symbol. This scenario is e.g. illustrated in FIG. 5.

In FIG. 5 four different set of network entities (set 1, set 2, set 3 and set 4, e.g. the previously described sets) are to be scheduled. For the sake of simplicity, the transmission intervals has been illustrated for each set, but transmissions for the sets are carried out simultaneously and hence the four illustrated intervals associated with the respective set should be seen as being superimposed over each other.

For set 1, uplink is scheduled in a first timing interval and only utilizes 50% of the symbols of that interval. Set 2 on the other hand utilizes 100% of the symbols of the first timing interval but for downlink. Hence there is capacity to utilize 50% of the symbols of the first timing interval for downlink transmissions. According to FIG. 5, set 3 has been scheduled for downlink using these 50% and set 4 is unallocated in the first timing interval.

In the second timing interval, set 1 is allocated 100% of the symbols for downlink, set 2 is allocated 50% for uplink, set 3 is unallocated and set 4 is allocated 50% for uplink.

In the third timing interval, set 1 is allocated 50% for uplink, set 2 is allocated 50% for downlink, set 3 is allocated 50% for uplink and set 4 is allocated 50% for downlink.

In the fourth timing interval, set 1 and set 2 are unallocated, and set 3 and set 4 are 100% allocated for respective uplink and downlink.

It should be noted that in the above example the term symbol has been used. However, the embodiments disclosed herein are not limited to symbols. The symbols in the above example should hence be seen just as an example. Instead of symbols, the term transmission period may be used, where a transmission interval may comprise one or more transmission periods. A transmission period may be measured in time or frequency.

In other words, in FIG. 5 the first set of network entities (set 1) has been allocated to some of the transmission periods, and the second, third and fourth set of network entities (set 2, set 3 and set 4) to some others of them. Hence, the first set of network entities and the second, third and fourth set of network entities share the same time interval but uplink and downlink have been scheduled in full duplex based on the transmission periods instead of the full intervals. This approach may enable several more sets of cells being scheduled while still utilizing and not exceeding the full IO capability and computing capability of the processing device.

In some embodiments, the scheduling according to the above scenarios (either when the number of cells correspond to the IO capabilities of the processing device, or when the number of cells exceed the IO capabilities of the processing device) may alternatively or additionally be based on the processing capabilities of the processing unit. Processing capabilities may e.g. relate to computing capabilities of the processing unit. Parameters such as size and memory of the processing unit may affect the processing capabilities.

E.g. in general it takes more processing resources to process uplink compared to downlink. Hence, processing capacity may be let up by scheduling the network entities such that fewer sets are scheduled for uplink in a same transmission interval compared to downlink scheduling and/or by scheduling the transmission patterns such that an uplink transmission is followed by several transmission interval holding downlink transmissions.

In some embodiments, the scheduling mechanism described herein can be used for energy saving. E.g. in a traffic scenario which does not require a continuously full allocation in all cells, the scheduler can aim at scheduling full allocations at the same time. I.e. instead of scheduling communication devices in the cells at different points in time it can try to schedule all communication device, in all cells, in uplink and downlink at the same time. This will typically cause a burst in processing but with good utilization, for a few TTIs followed by a silent period with no scheduled devices (i.e. no processing to be done during this time). The Processing Unit can during this silent period of time save power.

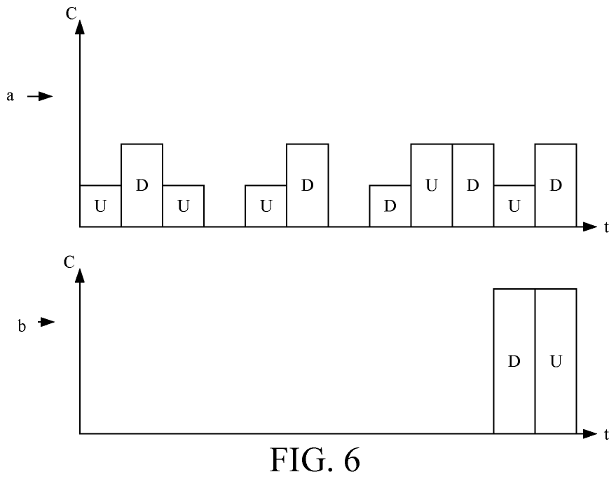

This scenario is illustrated in FIG. 6. In FIG. 6, the section noted “a” illustrates a transmission scenario for e.g. low traffic. The transmission intervals are not fully allocated (i.e. the maximum handling capacity C of the processing device is not reached in either of the transmission intervals), some are even left empty. In such a scenario, the processing device may instead schedule all uplink and downlink transmission as a single burst, which is shown the section noted “b” of FIG. 6. Here, instead of spreading the transmissions, they are gathered into two transmission intervals which are fully allocated. However, the time prior to and following this transmission burst may be used as a down time for the processing device, where it may enter a power saving mode.

It should be noted that the scheduling of the transmissions has been illustrated for only one set of network entities in FIG. 6, but that the embodiments according to FIG. 6 also applies when scheduling a plurality of sets.

Hence, in some embodiments, when there are lot of communication devices (or network entities associated with communication devices) to schedule it may be possible to schedule such that they all transmit simultaneously. However, as illustrated in FIG. 6 the method may comprise waiting a period of time to stock up communication devices to schedule, (i.e. gather work), and then schedule and process them all in one burst. In such a scenario, the processing device can enter a power saving mode both prior to and after the scheduling.

It should also be noted that it is not the time of the actual scheduling that is synchronized. It is the processing of the scheduled communication devices that are synchronized for a certain period of time by the scheduling.

The scenario of FIG. 6. may map on to the method 200 described in FIG. 2 in that the method 200 may further in some embodiments comprise that determining a network entity schedule comprises scheduling the plurality of network entities such that all active communication devices connected to each of the plurality of network entities are scheduled to transmit and receive in uplink and downlink respectively in each of the plurality of network entities at the same period of time, and the method may further comprise the processing device entering a power saving mode when all active communication devices have been scheduled.

In some embodiments, the scheduling may be based on processing synergies. E.g. there are synergies to be made when processing multiple network entities at the same time (e.g. FFT (fast Fourier transform) calculations of many IQ data slots that share the same numerology) The processing device may hence alternatively or additionally consider such synergies when scheduling multiple cells (or other network entities).

For example, Cell 1 has 45 communication devices to schedule for Uplink and Cell 3 has 45 communication devices to schedule for Uplink.

Since Cell 1 and 3 has 45 communication devices to schedule each, there are synergies that can be made if these are to be processed at the same time in the Processing device. The processing device may preferably schedule these communication devices at the same time, so that these are processed together in the Processing device.

Hence, in some embodiments, the method 200 as described in FIG. 2 may further comprise that determining a network entity schedule may be based on determining one or more synergies between one or more network entities of the plurality of network entities and scheduling the one or more network entities based on the determined synergies.

Data from several cells in the same function (at the same time) can e.g. according to some embodiments be processed. Processing a lot of data (data from many cells) in one function compared to processing the data from each cell individually is much more efficient. However, this typically is based on that the cells have similar characteristics, such as numerology.

Cells that share the same characteristics can hence be processed in the same function.

The described embodiments herein are applicable on 4G and 5G networks, and different Radio access Networks (RANs) may be mixed at scheduling uplink and downlink for different network entities.

A 4G network may in some embodiments be associated with a Long Term evolution (LTE) network.

A 5G network may in some embodiments be associated with a New Radio (NR) network.

FIG. 7 illustrates a computer program product 700 comprising a non-transitory computer readable medium according to some embodiments. The non-transitory computer readable medium 700 has stored there on a computer program comprising program instructions. The computer program is configured to be loadable into a data-processing unit 710, comprising a processor 720 (PROC) and a memory 730 (MEM) associated with or integral to the data-processing unit 710. When loaded into the data-processing unit 710, the computer program is configured to be stored in the memory 730, wherein the computer program, when loaded into and run by the processor 720 is configured to cause the execution of the method steps according to the embodiments described herein e.g. the method 200, and/or the method 200 combined with the embodiments described in conjunction with any of FIGS. 3-6.

FIG. 8 illustrates a processing device 800 for scheduling a plurality of network entities of a network for transmissions in uplink and downlink according to some embodiments. The processing device 800 may e.g. be the processing device as described in conjunction with any of the previous figures, and adapted to carry out any of the described embodiments. E.g. the embodiments according to the method 200.

The processing device 800 may comprise a controller 810 (CNTR, e.g. a controlling circuitry or controlling module) configured to cause determination (in some embodiments, the controller may comprise a determiner (DET) 812 which may e.g. be caused by the controller 810 to determine) of a handling capacity of the processing device. The handling capacity relates to a maximum number of network entities which the processing device can handle during a given period of time.

The controller 810 may also be configured to cause determination (e.g. by causing the determiner to determine) of a network entity schedule for transmission in uplink and downlink based on the handling capacity of the processing device by scheduling (the controller may e.g. comprise a scheduler or scheduling module (SCHED) 811 which may cooperate with the determiner and/or provide a cell schedule) a first set of network entities of the plurality of network entities to transmit in uplink and downlink in a transmission block according to a first transmission pattern, and cause scheduling (e.g. by causing the determiner and/or the scheduler) of a second set of network entities of the plurality of network entities to transmit in the transmission block in uplink and downlink according to a second transmission pattern. The first transmission pattern differs from the second transmission pattern and the first and second transmission patterns conform to the handling capacity of the processing device.

In some embodiments, the transmission block comprises transmission intervals, and all transmission intervals of the transmission block are fully allocated to the first and second set of network entities.

In some embodiments, the controller is configured to cause allocation of a first subset of transmission intervals of the block to the first and second set of network entities and wherein the network entity scheduling further comprises causing scheduling of a third set of network entities of the plurality of network entities to transmit in uplink and downlink in a second subset of transmission intervals the transmission block according to a third transmission pattern, and causing scheduling of a fourth set of network entities of the plurality of cells to transmit in uplink and downlink in the second subset of transmission intervals of the transmission block according to a fourth transmission pattern, wherein the first, second, third fourth transmission pattern differs from each other.

In some embodiments a transmission block is period measured in one or more of time and frequency.

In some embodiments, a transmission block comprises at least one transmission interval.

In some embodiments, a transmission block is a transmission interval.

In some embodiments, the transmission block comprises transmission intervals, and uplink and downlink is scheduled in a respective transmission interval.

In some embodiments, the transmission block comprises transmission intervals, and uplink and downlink is scheduled in a same transmission interval.

In some embodiments, the transmission block comprises at least one transmission interval, wherein the at least one transmission interval of the transmission blocks is fully allocated to the first and second set of network entities.

In some embodiments, uplink and downlink is scheduled in a respective transmission interval comprised in the transmission block.

In some embodiments, uplink and downlink is scheduled in a same transmission interval comprised in the transmission block.

In some embodiments, the handling capacity of the processing device is based on an Input vs Output (IO) capacity of the processing device.

In some embodiments, the handling capacity of the processing device is based on a computing capacity of the processing device.

In some embodiments, the network entity is at least one of a network cell, network section and network carrier for transmission.

In some embodiments, causing determination of a network entity schedule comprises causing scheduling of the plurality of network entities such that all active communication devices connected to each of the plurality of network entities are scheduled to transmit and receive in uplink and downlink respectively in each of the plurality of network entities at the same period of time, and the controller is further configured to cause entering into a power saving mode when all active communication devices have been scheduled.

In some embodiments, causing determination of a network entity schedule is based on causing determination of one or more synergies between one or more network entities of the plurality of network entities and causing scheduling of the one or more network entities based on the determined synergies.

In some embodiments, the processing device comprises hardware comprising one or more processing elements configured to process computations, in parallel.

In some embodiments, wherein the hardware is comprised in a GPU.

One advantage with the above described embodiments is that a node, processing many cells or other network entities, can be better utilized, which leads to that the overall network performance is enhanced.

The embodiments described herein provides a power efficient scheduling even though multiple network entities are handled.

The described embodiments and their equivalents may be realized in software or hardware or a combination thereof. They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of this disclosure.

Embodiments may appear within an electronic apparatus (such as a wireless communication device) comprising circuitry/logic or performing methods according to any of the embodiments. The electronic apparatus may, for example, be a portable or handheld mobile radio communication equipment, a mobile radio terminal, a mobile telephone, a base station, a base station controller, a pager, a communicator, an electronic organizer, a smartphone, a computer, a notebook, a USB-stick, a plug-in card, an embedded drive, or a mobile gaming device.

According to some embodiments, a computer program product comprises a computer readable medium such as, for example, a diskette or a CD-ROM. The computer readable medium may have stored thereon a computer program comprising program instructions. The computer program may be loadable into a data-processing unit, which may, for example, be comprised in a mobile terminal. When loaded into the data-processing unit, the computer program may be stored in a memory associated with or integral to the data-processing unit. According to some embodiments, the computer program may, when loaded into and run by the data-processing unit, cause the data-processing unit to execute method steps according to, the embodiments described herein.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely for illustrative purpose and by no means limiting. Instead, all variations that fall within the range of the claims are intended to be embraced therein.

1. A method of a processing device for scheduling a plurality of network entities of a network for transmissions in uplink and downlink, the method comprising:
determining a handling capacity of the processing device, the handling capacity relating to a maximum number of network entities which the processing device can handle during a given period of time; and
determining a network entity schedule for transmission in uplink and downlink based on the handling capacity of the processing device by scheduling a first set of network entities of the plurality of network entities to transmit in uplink and downlink in a transmission block according to a first transmission pattern, and scheduling a second set of network entities of the plurality of network entities to transmit in the transmission block in uplink and downlink according to a second transmission pattern, the first transmission pattern differing from the second transmission pattern in that uplink transmissions in the first transmission pattern are not scheduled in a same transmission interval comprised in the transmission block as uplink transmissions of the second transmission pattern, and the first and second transmission patterns conforming to the handling capacity of the processing device.

2. The method according to claim 1, wherein the transmission blocks comprises at least one transmission interval, wherein the at least one transmission interval of the transmission block are fully allocated to the first and second set of network entities.

3. The method according to claim 1, wherein a first subset of transmission intervals of the transmission block is allocated to the first and second set of network entities and wherein the network entity scheduling further comprises:
scheduling a third set of network entities of the plurality of network entities to transmit in uplink and downlink in a second subset of transmission intervals of the transmission block according to a third transmission pattern, and scheduling a fourth set of network entities of the plurality of network entities to transmit in uplink and downlink in the second subset of transmission intervals of the transmission block according to a fourth transmission pattern, wherein the first, second, third fourth transmission pattern differs from each other.

4. The method according to claim 1, wherein the transmission block is a period measured in one or more of time and frequency.

5. (canceled)

6. (canceled)

7. The method according to claim 1, wherein the handling capacity of the processing device is based on an Input vs Output (IO) capacity of the processing device.

8. The method according to claim 1, wherein the handling capacity of the processing device is based on a computing capacity of the processing device.

9. The method according to claim 1, wherein a network entity is at least one of a network cell, network section, radio unit and a network carrier for transmission.

10. The method according to claim 1, wherein determining a network entity schedule comprises scheduling the plurality of network entities such that all active communication devices connected to each of the plurality of network entities are scheduled to transmit and receive in uplink and downlink respectively in each of the plurality of network entities at the same period of time, and the method further comprises the processing device entering a power saving mode when all active communication devices have been scheduled.

11. The method according to claim 1, wherein determining a network entity schedule is based on determining one or more synergies between one or more network entities of the plurality of network entities and scheduling the one or more network entities based on the determined synergies.

12. A non-transitory computer readable storage device storing and executable computer program comprising program instructions, the computer program is configured to be loadable into a data-processing unit, comprising a processor and a memory one of associated with and integral to the data-processing unit, which when executed performs a method for scheduling a plurality of network entities of a network for transmissions in uplink and downlink, the method comprising:
determining a handling capacity of the processing device, the handling capacity relating to a maximum number of network entities which the processing device can handle during a given period of time; and
determining a network entity schedule for transmission in uplink and downlink based on the handling capacity of the processing device by scheduling a first set of network entities of the plurality of network entities to transmit in uplink and downlink in a transmission block according to a first transmission pattern, and scheduling a second set of network entities of the plurality of network entities to transmit in the transmission block in uplink and downlink according to a second transmission pattern, the first transmission pattern differing from the second transmission pattern in that uplink transmissions in the first transmission pattern are not scheduled in a same transmission interval comprised in the transmission block as uplink transmissions of the second transmission pattern, and the first and second transmission patterns conforming to the handling capacity of the processing device.

13. A processing device for scheduling a plurality of network entities of a network for transmissions in uplink and downlink, the processing device comprising a controller configured to cause:
determination of a handling capacity of the processing device, the handling capacity relating to a maximum number of network entities which the processing device can handle during a given period of time; and
determination of a network entity schedule for transmission in uplink and downlink based on the handling capacity of the processing device by scheduling a first set of network entities of the plurality of network entities to transmit in uplink and downlink in a transmission block according to a first transmission pattern, and cause scheduling of a second set of network entities of the plurality of network entities to transmit in the transmission blocks in uplink and downlink according to a second transmission pattern, the first transmission pattern differing from the second transmission pattern in that uplink transmissions in the first transmission pattern are not scheduled in a same transmission interval comprised in the transmission block as uplink transmissions of the second transmission pattern and the first and second transmission patterns conform to the handling capacity of the processing device.

14. The processing device according to claim 13, wherein the transmission block comprises at least one transmission interval, wherein the at least one transmission interval of the transmission block is fully allocated to the first and second set of network entities.

15. The processing device according to claim 13, wherein the controller is configured to cause allocation of a first subset of transmission intervals of the transmission block to the first and second set of network entities and wherein the network entity scheduling further comprises:
causing scheduling of a third set of network entities of the plurality of network entities to transmit in uplink and downlink in a second subset of transmission intervals of the transmission block according to a third transmission pattern; and
causing scheduling of a fourth set of network entities of the plurality of network entities to transmit in uplink and downlink in the second subset of transmission intervals of the transmission block according to a fourth transmission pattern, wherein the first, second, third fourth transmission pattern differs from each other.

16. The processing device according to claim 13, wherein the transmission block is period measured in one or more of time and frequency.

17. (canceled)

18. (canceled)

19. The processing device according to claim 13, wherein the handling capacity of the processing device is based on an Input vs Output (IO) capacity of the processing device.

20. The processing device according to claim 13, wherein the handling capacity of the processing device is based on a computing capacity of the processing device.

21. The processing device according to claim 13, wherein device network entity is at least one of a network cell, network section, radio unit and network carrier for transmission.

22. The processing device according to claim 13, wherein causing determination of a network entity schedule comprises causing scheduling of the plurality of network entities such that all active communication devices connected to each of the plurality of network entities are scheduled simultaneously to transmit and receive in uplink and downlink respectively in each of the plurality of network entities at the same period of time, and the controller is further configured to cause entering into a power saving mode when all active communication devices have been scheduled.

23. The processing device according to claim 13, wherein causing determination of a network entity schedule is based on causing determination of one or more synergies between one or more network entities of the plurality of network entities and causing scheduling of the one or more network entities based on the determined synergies.

24. The processing device according to claim 13, wherein the processing device comprises hardware comprising one or more processing elements configured to process computations, in parallel and wherein the hardware is comprised in a graphics processing unit, GPU.

25. (canceled)
